(19) United States
(12) Patent Application Publication
(10) Pub. No.: US 2025/0310693 A1
(43) Pub. Date: Oct. 2, 2025

(54) COMMUNICATION EQUIPMENT ALLOWING FULL DUPLEX WITH SOUND PICK-UP IN THE EAR, AND COMMUNICATION SYSTEM COMPRISING SAME

(71) Applicant: INSTITUT FRANCO-ALLEMAND DE RECHERCHES DE SAINT-LOUIS, SAINT-LOUIS (FR)

(72) Inventors: Véronique ZIMPFER, COLMAR (FR); Pascal HAMERY, RIEDISHEIM (FR)

(21) Appl. No.: 18/866,319

(22) PCT Filed: May 2, 2023
(86) PCT No.: PCT/IB2023/054540

§ 371 Date: Feb. 4, 2025

(30) Foreign Application Priority Data
May 16, 2022 (FR) FR2204619

(51) Int. Cl. H04R 5/04; H04R 3/12; H04R 5/033

(52) U.S. Cl. CPC H04R 5/04; H04R 3/12; H04R 5/033

(57) ABSTRACT

A communication device comprising a first device and a second device, each comprising a first microphone and a loudspeaker, the communication device being configured in such a way that a first speech signal provided to the loudspeaker and a second speech signal provided to the loudspeaker are in phase opposition, each microphone being configured to pick up at least one voice from the user and a sound from the loudspeaker, the communication device-further comprising a first summer configured to receive as input and to sum the output signal corresponding to the first device and the output signal corresponding to the second device, the first summer outputting the total output signal equal to the sum of the output signal corresponding to the first device and the output signal corresponding to the second device, and the total output signal comprising a user voice component and being free of any component of the at least one source speech signal.

The present invention relates to the technical field of communication systems with in-ear sound pickup for the user, and more particularly to a communication device enabling full-duplex operation with in-ear sound pickup and to a communication system comprising the same.

To date, the vast majority of communication devices that use in-ear sound pickup for voice capture rely on a push-to-talk (PTT) button. This button allows to interrupt the sound emitted by the loudspeaker located in the ear, right next to the microphone used for sound pickup. Such devices enable half-duplex communication. Without using the PTT button, the microphone in the user's ear canal simultaneously and inseparably records the user's voice, the voice of the interlocutor(s), and possibly a restitution of the user's sound environment. Indeed, many of these devices also implement a pass-through or talk-through system for the user. This restitution is necessary essential to avoid isolating the user from his/her acoustic environment, particularly when the device includes in-ear hearing protection. It is understood that half-duplex communication relying on the use of a PTT button can be restrictive, particularly during a conversation. An alternative to the PTT button is the use of a voice activity detector (VAD), which, upon detecting the user's speech activity, automatically pauses both the speech communication signal and environmental sound restitution while recording the user's voice. However, this system also has disadvantages, particularly the risk of unintended interruptions of the speech signal emission and of the environmental sound restitution when the user speaks directly with a nearby person, without engaging a radio communication system. Furthermore, conventional echo-cancellation algorithms cannot be applied to in-ear sound pickup communication devices because the microphone pickup is too close to the loudspeaker. It is, therefore, challenging to implement full-duplex communication.

In the prior art, the European patent application EP3188507 A1 proposes a portable hearing device enabling near-full-duplex communication with sound environment restitution. In this document, the sound of the source speech signal and the sound of the sound environment restitution, picked up by the pickup microphone in the ear, are attenuated in the return speech signal by the use of an electronic compensation filter circuit using an estimated transfer function modeling the acoustic transfer function in the ear of the user between the loudspeaker and the pickup microphone of the device. However, this solution presents certain drawbacks: the compensation scheme is complex, the transfer function can be difficult to model, and its efficiency remains limited, particularly at low frequencies. This solution is also unsuitable for use with hearing protection. This document EP3188507 A1 relates to hearing aids in particular. It does not apply to a hearing protector whose sealing with the exterior is maximum, which is the aim sought for in a hearing protector. In EP3188507 A1, the stability of the internal speaker/microphone transfer function is essential, especially at low frequencies. Furthermore, this document is unable to handle a large calculation load.

Consequently, prior art solutions proposed for in-ear sound pickup communication devices still present drawbacks, and improvements are possible.

In particular, the invention aims to propose communication device, particularly at least partly intra-auricular, configured to enable full-duplex communication with in-ear sound pickup.

A further objective of the invention is to propose a communication device configured to generate a return speech signal.

A further objective of the invention is to propose a communication device configured to provide a simple and effective echo-cancellation function to avoid echoing his/her voice back to the interlocutor and avoid acoustic feedback.

A further objective of the invention is to propose a communication device configured to provide an echo-cancellation function by transmitting the voice signal in phase opposition to the user's right and left ears.

A further objective of the invention is to propose a communication device configured to allow sound environment restitution to the user.

A further objective of the invention is to propose a communication device configured to minimize the sound environment restitution sent to the interlocutor or interlocutors.

A further objective of the invention is to propose a communication device configured to render the sound environment to the user in an attenuated manner.

A further objective of the invention is to propose a communication device configured to allow a user to simultaneously speak and listen to a speech signal and, if required, a restitution of the sound environment without pressing a button.

A further objective of the invention is to propose a communication device comprising an in-ear hearing protector.

A further objective of the invention is to propose a communication system allowing full-duplex communication with in-ear sound pickup using communication apparatuses and communication devices according to the invention.

Thus, the present invention has as its object a communication device allowing full duplex with in-ear sound pickup, the communication device being configured to receive at least one source speech signal transmitted by at least one communication apparatus and to provide a total output signal, the communication device comprising: a first device designed to be inserted into one from among a right ear and a left ear of a user, and a second device designed to be inserted into the other from among the right ear and the left ear of the user; each from among the first device and the second device comprising a first microphone and a loudspeaker configured to be arranged, in use, facing an ear canal of the user; characterized in that: the communication device is configured in such a way that a first speech signal is provided to the loudspeaker of the first device and a second speech signal is provided to the loudspeaker of the second device, the first and second speech signals being based on the at least one source speech signal in such a way that the first speech signal and the second speech signal are in phase opposition, namely phase-shifted by Pi; the first microphone of the first, respectively second, device is configured to pick up, in the respective ear, at least one voice of the user and a sound of the first, respectively second, speech signal generated by the loudspeaker of the first, respectively second, device, and to output a sound pickup signal of the first, respectively second, device; the communication device is configured to generate a pre-output signal corresponding to the first device, and a pre-output signal corresponding to the second device, respectively from the pickup signal of the first and second devices, and to generate an output signal corresponding to the first device and an output signal corresponding to the second device, respectively comprising at least one component related to the pre-output signal corresponding to the first device and a component related to the pre-output signal corresponding to the second device; and the communication device further comprises a first summer configured to receive as input and to sum the output signal of the first device and the output signal of the second device, the first summer outputting the total output signal equal to the sum of the output signal of the first device and the output signal of the second device, and the total output signal comprising a user voice component and being free of components of the first and second speech signals.

An in-ear sound pickup communication device according to the embodiment described above allows the source speech signal to be continuously transmitted to the ears of the user and a total output signal to be obtained comprising only a component corresponding to the user's voice. This allows full-duplex communication to be put in place. The source speech signal, generally the voice of the interlocutor, is transmitted in phase opposition, in other words, phase-shifted by Pi, in the right and left ears, in such a way that the summation of the sound pickup in the right ear and the sound pickup in the left ear eliminates the sound associated with the source speech signal.

The communication device according to this embodiment is therefore configured to implement a simple and highly effective echo-cancellation function.

The communication device may possibly receive source speech signals coming from several communication apparatuses, in which case the communication device is configured to combine the various source speech signals received.

The communication apparatuses may, for example, be a radio, a walkie-talkie, a telephone, a smartphone, a digital tablet, or a computer.

According to one embodiment, the communication device further comprises a total output signal processing module configured to process the total output signal in order to generate, from the total output signal, at least one from among a return speech signal and two return speech signals in phase opposition, the processing being at least one from among a decrease in the occlusion effect, a decrease in the bone transmission effect, and an amplification, in order to make the total output signal more natural for the interlocutor.

In the case of an in-ear sound pickup, due to the occlusion effect and the bone transmission effect, the voice, in other words, the user's speech signal, captured in the ear is strongly amplified in the low-frequency range, particularly below 500 Hz. The processing of the total output signal can therefore, for example, consist of a processing allowing the sound of the voice of the user to be rendered more natural for the interlocutor, in order to improve speech quality and intelligibility.

According to one embodiment, the communication device is configured to receive two source speech signals in phase opposition coming from each communication apparatus, to use one of the two source speech signals in order to generate the first speech signal and provide it to the loudspeaker of the first device, and to use the other of the source speech signals to generate the second speech signal and provide it to the loudspeaker of the second device.

According to one embodiment, the communication device comprises a source speech signal processing module configured to receive a single source speech signal coming from each communication apparatus and to generate the first speech signal and the second speech signal in phase opposition from the at least one source speech signal.

According to one embodiment, the communication device is configured to phase shift by Pi the at least one source speech signal in order to generate the first speech signal, and to not phase shift the source speech signal in order to generate the second speech signal.

It will be understood that the various embodiments described above are configurations that allow transmission in phase opposition, in other words, with a phase shift of Pi, in the right ear and the left ear in such a way that the summation of the sound pickup in the right ear and the sound pickup in the left ear eliminates the sound associated with the source speech signal.

According to one embodiment, at least one device, referred to as a sound environment restitution device, from among the first device and the second device, comprises a second microphone, arranged on an external surface of the at least one sound environment restitution device and directed toward the exterior, the second microphone being configured to pick up an environmental noise and output an environmental noise source signal from the at least one sound environment restitution device; the communication device being configured to generate an environmental noise signal corresponding to the at least one sound environment restitution device from the environmental noise source signal; the communication device further comprises, for each sound environment restitution device: a second summer configured to receive as input and to sum the environmental noise signal corresponding to the at least one sound environment restitution device and the speech signal configured to be provided to the loudspeaker of the at least one sound environment restitution device, and to output the sum to the loudspeaker of the at least one sound environment restitution device; a filter module, connected to the second microphone, configured to receive the environmental noise signal corresponding to the at least one sound environment restitution device, to filter the environmental noise signal corresponding to the at least one sound environment restitution device by an estimated transfer function, and output a filtered environmental noise signal; and a mixer, the first microphone of the at least one sound environment restitution device being further configured to pick up, in the respective ear, an environmental noise signal sound corresponding to the at least one sound environment restitution device generated by the loudspeaker of the at least one sound environment restitution device, the mixer being configured to receive as input and to subtract the pre-output signal corresponding to the at least one sound environment restitution device and the filtered environmental noise signal, and to output the output signal corresponding to the at least one sound environment restitution device, the output signal corresponding to the at least one sound environment restitution device being equal to the pre-output signal corresponding to the at least one sound environment restitution device from which the filtered environmental noise signal is subtracted, and the output signal corresponding to the at least one sound environment restitution device being free of the environmental noise signal component corresponding to the at least one sound environment restitution device; for each sound environment restitution device, the estimated transfer function modeling a global transfer function between the second summer and the mixer.

Implementing a sound environment restitution allows isolating the user from his/her acoustic environment to be avoided, for example, to facilitate a conversation with a nearby person who is not using a communication system, or to allow faster detection of an audible alarm.

Preferably, both first device and second device of the communication device are sound environment restitution devices.

The estimated transfer function models a “global” transfer function between the second summer and the mixer, in other words, over the entire path allowing restitution of the sound environment to the user, in order to be able to eliminate restitution of the sound environment at the mixer. In particular, the estimated transfer function models a possible loudspeaker power amplification electronic circuit, the loudspeaker, the acoustic transfer function in the ear of the user between the first microphone and the loudspeaker of the corresponding device, and a possible post-microphone power amplification module.

According to one embodiment, the communication device further comprises, for each sound environment restitution device, an adaptive gain module allowing to attenuate the environmental noise source signal of the at least one sound environment restitution device before generating the environmental noise signal corresponding to the at least one sound environment restitution device intended for transmission to the loudspeaker of the at least one sound environment restitution device.

Attenuating the environmental noise signal allows the sound level of the sound restitution to be reduced to prevent damage to the hearing of the user. In order to promote the elimination of the environmental noise signal component in the output signal of an environmental sound restitution device, the environmental noise signal attenuation is performed in the same way on the environmental noise signal intended for transmission to the electronic filter circuit and on the environmental noise signal intended for transmission to the loudspeaker before any bifurcation.

According to one embodiment, the attenuation of the environmental noise source signal of the at least one sound environment restitution device depends on a sound level of the environmental noise signal.

The modifying of the attenuation as a function of the sound level of the environmental noise allows to optimize the sound level of the environmental sound restitution while preventing degradation of the user's hearing.

According to one embodiment, the communication device is configured so that the attenuation allows the sound level of the environmental noise signal corresponding to the at least one sound environment restitution device generated by the loudspeaker of the at least one sound environment restitution device to always be less than a threshold value.

The use of a threshold value allows guaranteeing that the user's hearing is not impaired. Preferably, the communication device is configured so that a sound level at an eardrum of the user is less than or equal to 75 dBA with respect to the free field.

According to one embodiment, at least one operation executed by the communication device, on the at least one source speech signal or on an intermediate signal between the at least one source speech signal and the total output signal, is executed by a processor.

According to one embodiment, the total output signal processing module is implemented by at least one from among a processor, a microcontroller, a microprocessor, a digital signal processor (DSP), a field-programmable gate array (FPGA), or an application-specific integrated circuit (ASIC).

The communication device according to the invention is thus suitable for a high computing load.

According to one embodiment, at least one from among the first device and the second device is an in-ear hearing protector.

The use of an in-ear hearing protector allows the ear canal of the user to be isolated from the outside world, thus improving the quality of use of the communication device.

The present invention also has as its object a communication system able to allow a user to participate in full-duplex communication with at least one interlocutor with in-ear sound pickup for the user, characterized in that the system comprises communication device such as described above for the user, at least one user communication apparatus for the user and at least one interlocutor communication apparatus for each interlocutor, each user communication apparatus being able to communicate with at least one of the interlocutor apparatuses, each user communication apparatus being configured to transmit at least one source speech signal to the user communication device, and the user communication device being configured to output a total output signal intended to generate at least one return speech signal intended to be transmitted to at least one of the interlocutor communication apparatuses by one of the user communication apparatuses; the interlocutors possibly using communication device as described above.

According to one embodiment, at least one of the communication apparatuses is one from among a radio, a walkie-talkie, a telephone, a smartphone, a digital tablet, or a computer.

A communication device according to one embodiment of the present invention and a communication system according to the present invention will now be described by way of non-limiting examples, with reference to the appended drawing.

In this drawing:

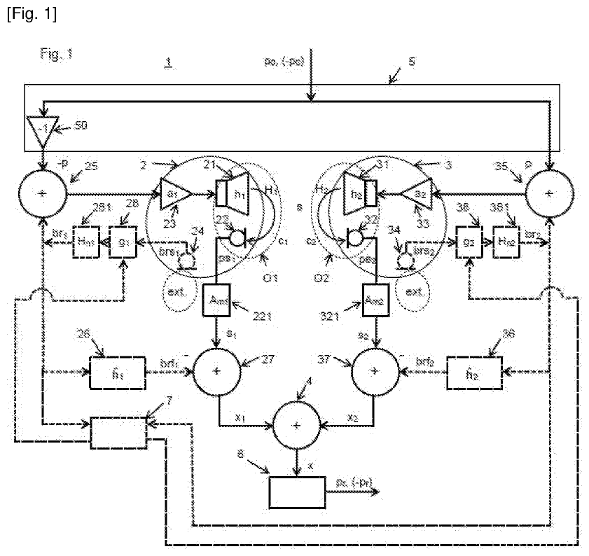

FIG. 1 is a schematic functional representation of a communication device according to the present invention, the elements which allow the restitution of the sound environment are represented in dotted lines.

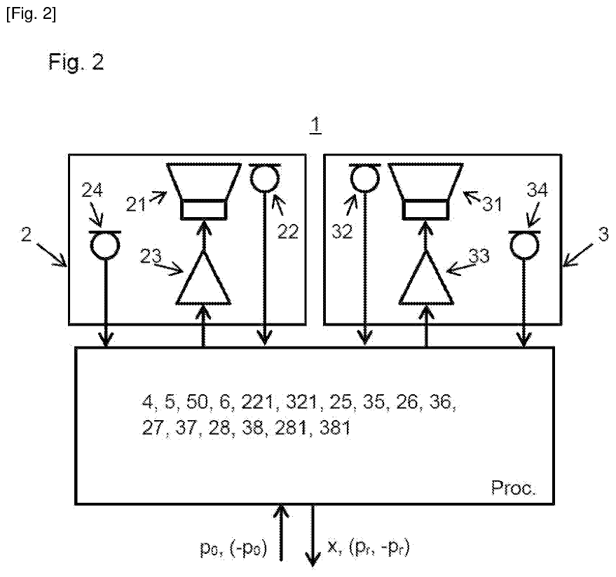

FIG. 2 is a schematic representation of a communication device according to a preferred embodiment of the present invention.

Referring to FIG. 1, it can be seen that a communication device 1, according to the present invention, is represented, comprising a first device 2, a second device 3, a first summer 4, and a source speech signal processing module 5. The first device 2 is intended to be inserted into a first ear O1 of a user and the second device 3 is intended to be inserted into a second ear O2 of the user. According to the embodiment represented in FIG. 1, the first ear O1 corresponds to the left ear and the second ear O2 corresponds to the right ear. Alternatively, the first ear O1 can be the right ear and the second ear O2 the left ear. Preferably, the first device 2 and the second device 3 present the form of in-ear hearing protectors but can take the form of any type of element configured to be inserted into an ear of a user O1, O2, such as earpieces or headphones.

The first device 2 and the second device 3 each comprise a loudspeaker 21, 31 and a first microphone 22, 32 configured to be arranged, in use, facing a respective ear canal of the user. The loudspeaker 21, 31 is configured to generate sounds in the respective ear O1, O2 and the first microphone 22, 32 is configured to pick up sounds in the respective ear O1, O2.

The source speech signal processing module 5 is configured to receive a source speech signal p₀ transmitted by a communication apparatus, for example a radio, a walkie-talkie, a telephone, a smartphone, a digital tablet, or a computer, and to generate, from the source speech signal p₀, a first speech signal −p and a second speech signal p in phase opposition, in other words, phase shifted by Pi or 180°. The first speech signal −p is provided to the loudspeaker 21 of the first device 2, and the second speech signal p is provided to the loudspeaker 31 of the second device 3.

According to the embodiment represented in FIG. 1, the source speech signal processing module 5 comprises a phase shifting module 50, configured to phase shift by Pi, in other words, 180°, the source speech signal p₀ received by the communication device 1 so as to generate a first speech signal −p intended for the first device 2, in phase opposition relative to the source speech signal p₀, and the source speech signal processing module 5 is configured to not phase-shift the source speech signal p₀ in order to generate a second source speech signal p intended for the second device 3. The skilled person will understand that, alternatively, other solutions are possible to obtain a first speech signal −p and a second speech signal p in phase opposition. For example, the source speech signal processing module 5 could be configured to phase shift by Pi, in other words, 180°, the source speech signal p₀ received by the communication device 1 so as to generate a second speech signal, intended for the second device 3, in phase opposition relative to the source speech signal p₀, and the source speech signal processing module 5 would then be configured not to phase shift the source speech signal p₀ in order to generate a first speech signal intended for the first device 2. Alternatively, the source speech signal processing module 5 could comprise a first phase shifting module configured to phase shift by +Pi/2, in other words, +90°, the source speech signal p₀ received by the communication device 1 so as to generate the first speech signal, and the source speech signal processing module 5 would then comprise a second phase shifting module (not represented) configured to phase shift by −Pi/2, in other words, −90°, the source speech signal p₀ received by the communication device 1 so as to generate the second speech signal. As another alternative, the first phase shifting module could phase shift the source speech signal p₀ by −Pi/2 and the second phase shifting module (not represented) could phase shift the source speech signal p₀ by +Pi/2. It will be understood that other combinations of phase shifts are possible in order to obtain a first speech signal −p and a second speech signal p in phase opposition.

Furthermore, as an alternative to the embodiment represented in FIG. 1, the communication device 1 can be configured to receive two source speech signals p₀ and −p₀ in phase opposition transmitted by the communication apparatus, in such a way that one, p₀, of the two source speech signals p₀ and −p₀ is used as the first speech signal −p and is provided to the loudspeaker 21 of the first device 2, and the other p₀ of the two source speech signals p₀ and −p₀ is used as the second speech signal p and is provided to the loudspeaker 31 of the second device 3.

The communication device 1 may possibly receive source speech signals p₀ coming from several communication apparatuses, in which case the source speech signal processing module 5 is configured to combine the different source speech signals p₀ received.

Preferably, the source speech signal processing module 5 is configured to calculate a sound level associated with the source speech signal p₀. Even more preferably, the source speech signal processing module 5 is configured to allow an adaptive adjustment of the gain of the source speech signal p₀ before generating the speech signals −p and p, preferably as a function of a calculated sound level of the source speech signal p₀.

The loudspeaker 21 of the first device 2 is configured to generate at least one sound from the first speech signal −p, and the loudspeaker 31 of the second device 3 is configured to generate at least one sound from the second speech signal p.

Preferably, the first loudspeaker 21 and the second loudspeaker 31 each comprise an electronic power amplification circuit 23, 33, for the loudspeaker 21, 31 for example, an amplifier configured to adjust a power amplification of the signal entering the corresponding loudspeaker 21, 31.

Preferably, the loudspeakers 21, 31 of the first device 2 and second device 3 are identical. Even more preferably, the power amplification of the electronic power amplification circuit 23, 33 of the loudspeaker are identical for both loudspeakers 21, 31. It will be understood that if the loudspeakers 21, 31 are different, the power amplifications are preferably adjusted so that the same signal generates the same sound for each loudspeaker 21, 31.

The first microphone 22 of the first device 2 is configured to at least pick up, in the first ear O1 of the user, a voice s of the user and the sound of the first speech signal −p generated by the loudspeaker 21 of the first device 2 in order to output a sound pickup signal ps₁ of the first device 2. The first microphone 32 of the second device 3 is configured to at least pick up, in the second ear O2 of the user, the voice s of the user and the sound of the second speech signal p generated by the loudspeaker 31 of the second device 3, in order to output a sound pickup signal ps₂ of the second device 3.

Preferably, the communication device 1 comprises a post-microphone power amplification module 221, 321 for each first and second device 2, 3, configured to adjust, respectively, a power amplification of the sound pickup signal ps₁ of the first device 2 and of the sound pickup signal ps₂ of the second device 3, in order to generate pre-output signals s₁, s₂ corresponding, respectively, to the first device 2 and to the second device 3.

It will be understood that if the communication device 1 does not comprise a post-microphone power amplification module 221, 321, then the pre-output signal s₁, s₂ is equal to the sound pickup signal ps₁, ps₂.

Preferably, the first microphones 22, 32 of the first and second devices 2, 3 are identical. Even more preferably, the power amplifications of the post-microphone power amplification modules 221, 321 are identical for the two sound pickup signals ps₁, ps₂. It will be understood that if the first microphones 22, 32 of the two first and second devices 2, 3 are different, the power amplifications are preferably adjusted so that the same sound generates the same pre-output signal s₁, s₂ corresponding, respectively, to the first device 2 and the second device 3.

Furthermore, in practice it may happen that the first ear O1 of the user and the second ear O2 of the user have different characteristics. In this case, it will be understood that, preferably, the power amplifications of the loudspeaker power amplification electronic circuits 23, 33 and of the post-microphone power amplification modules 221, 321 are adjusted so that the communication device 1 is configured in such a way that, for each first and second device 2, 3, the same “first signal” entering the loudspeaker 21, 31 generates the same pre-output signal s₁, s₂.

In particular, if h₁, respectively h₂, denotes the transfer function of the loudspeaker 21 of the first device 2, respectively the transfer function of the loudspeaker 31 of the second device 3, a₁, respectively a₂, the power amplification of a possible loudspeaker electronic power amplification circuit 23 of the loudspeaker 21 of the first device 2, respectively the power amplification of a possible loudspeaker electronic power amplification circuit 33 of the loudspeaker 31 of the second device 3, H₁, respectively H₂, the acoustic transfer function in the first ear O1 between the first microphone 22 and loudspeaker 21, respectively the acoustic transfer function in the second ear O2 between the first microphone 32 and loudspeaker 31, and Aₘ₁, respectively Aₘ₂, the power amplification of a possible power amplification module 221 associated with the first device 2, respectively the power amplification of a possible power amplification module 321 associated with the second device 3, then preferably a₁, Aₘ₁, a₂ and Aₘ₂ are adjusted so that h₁×a₁×H₁×Aₘ₁=h₂×a₂×H₂×Aₘ₂=h×a×H×Aₘ.

The communication device 1 is configured to generate an output signal x₁ corresponding to the first device 2, and an output signal x₂ corresponding to the second device 3. Furthermore, the first summer 4 is configured to sum the output signal x₁ corresponding to the first device 2 and the output signal x₂ corresponding to the second device 3 in order to obtain a total output signal x.

It can be specified that without sound environment restitution, the output signal x₁ corresponding to the first device 2 is equal to the pre-output signal s₁ corresponding to the first device 2, and the output signal x₂ corresponding to the second device 3 is equal to the pre-output signal s₂ corresponding to the second device 3. This is different in the case of a sound environment restitution, and this configuration will be described in detail later.

With reference to FIG. 1, the operating principle of the invention can be illustrated mathematically, without restitution of the sound environment, by noting c₁ the transfer function of the speaker bone conduction for the first ear O1 of the user, c₂ the transfer function of the speaker bone conduction for the second ear O2 of the user, then:

$$x = {x}_{1} + {x}_{2} = {s}_{1} + {s}_{2} , then$$

$$x = p {s}_{1} \times {A}_{m 1} + p {s}_{2} \times {A}_{m 2} , then$$

$$x = ( s \times {c}_{1} - p \times {h}_{1} \times {a}_{1} ) \times {H}_{1} \times {A}_{m 1} + ( s \times {c}_{2} + p \times {h}_{2} \times {a}_{2} ) \times {H}_{2} \times {A}_{m 2} , then$$

$$x = s \times ( {c}_{1} \times {H}_{1} \times {A}_{m 1} + {c}_{2} \times {H}_{2} \times {A}_{m 2} ) - p \times ( {h}_{1} \times {a}_{1} \times {H}_{1} \times {A}_{m 1} ) + p \times ( {h}_{2} \times {a}_{2} \times {H}_{2} \times {A}_{m 2} )$$

In a theoretical case, we can assume that the speaker bone conduction and the acoustic transfer function are identical for the first and second ears O1, O2, in other words, c₁=c₂=c and H₁=H₂=H, since the head of the user is symmetrical, that the transfer functions of the loudspeakers 21, 31 are identical, in other words, h₁=h₂=h, since the loudspeakers 21, 31 are identical, and that the power amplifications are identical, in other words, a₁=a₂=a et Aₘ₁=Aₘ₂=Aₘ.

$$This gives x = 2 \times s \times c \times H \times {A}_{m} .$$

In practice, it may happen that the loudspeakers 21, 31 or the first microphones 22, 32 are not strictly identical, or that the characteristics of the right and left ears of the user are slightly different. In this case, the communication device 1 is preferably configured to compensate for these differences, for example by slightly adjusting the power amplifications of the loudspeaker electronic power amplification circuits 23, 33 and the post-microphone power amplification modules 221, 321, in such a way that h₁×a₁×H₁×Aₘ₁=h₂×a₂×H₂×Aₘ₂=h×a×H×Aₘ.

Repeating the above equation then gives:

$$x = s \times ( {c}_{1} \times {H}_{1} \times {A}_{m 1} + {c}_{2} \times {H}_{2} \times {A}_{m 2} )$$

$$x = s \times {H}_{1} \times {A}_{m 1} \times ( {c}_{1} + {c}_{2} \times \frac{{h}_{1} \times {a}_{1}}{{h}_{2} \times {a}_{2}} ) .$$

Thus, the total output signal is free of the voice signal components-p, p, in such a way that the communication device 1 allows an echo-cancellation function.

In the case of in-ear sound pickup, due to the occlusion effect and bone transmission effect, the voice s, in other words, the speech signal of the user, is strongly amplified in the low-frequency range, particularly below 500 Hz. Preferably, the total output signal x is therefore processed before being transmitted to a communication apparatus, using a total output signal processing module 6, in order to reduce the occlusion effect and the bone transmission effect to make the sound of the voice s of the user more natural for the interlocutor, and thus improve speech quality and intelligibility. These treatments are already known, for example, from the work of Elliott H. Berger, Ronald W. Kieper, Dan Gauger, “Hearing protection: Surpassing the limits to attenuation imposed by the bone-conduction pathways” J. Acoust. Soc. Am, Vol. 114, No. 4, Pt. 1, October 2003, and will not be detailed here.

The total output signal processing module 6 may possibly also comprise an amplification module.

As represented in FIG. 1, the communication device 1 may further comprise a sound environment restitution function. According to the embodiment represented in FIG. 1, each first and second device 2, 3 further includes a second microphone 24, 34, and the communication device 1 further comprises, for each first and second device 2, 3, a second summer 25, 35, a filter module 26, 36 and a mixer 27, 37, respectively.

The second microphones 24, 34 are arranged on an external surface of the corresponding device 2, 3 and, in use, are directed toward the exterior. The second microphones 24, 34 are configured to pick up sounds from the exterior ext of the communication device 1, in particular environmental noise, and to output an environmental noise source signal brs₁ from the first device 2 and an environmental noise source signal brs₂ from the second device 3.

For a restitution of the sound environment, the second summer 25 associated with the first device 2 is configured to receive as input the first speech signal −p and an environmental noise signal br₁ corresponding to the first device 2, the environmental noise signal br₁ corresponds to the environmental noise source signal brs₁ of the first device 2, possibly adjusted in gain and corrected as will be detailed later, and to output the sum of these two signals to the loudspeaker 21 of the first device 2. Similarly, the second summer 35 associated with the second device 3 is configured to receive as input the second speech signal p and an environmental noise signal br₂ corresponding to the second device 3, the environmental noise signal br₂ corresponding to the environmental noise source signal brs₂ of the second device 3, possibly adjusted in gain and corrected as will be detailed later, and to output the sum of these two signals to the loudspeaker 31 of the second device 3.

In the case of sound environment restitution, the loudspeakers 21, 31 are configured, in addition, to generate a sound of the environmental noise signal br₁, br₂ and the first microphones 22, 32 are configured, in addition, to pick up in the respective ear O1, O2 the sound of the environmental noise signal br₁, br₂ generated by the corresponding loudspeaker 21, 31.

The filter module 26, 36 associated with each device 2, 3 is configured to receive as input the environmental noise signal br₁, br₂ corresponding to said device 2, 3, and to output a filtered environmental noise signal brf₁, brf₂. The filtering is executed by an estimated transfer function ĥ₁, ĥ₂ modeling a “global” transfer function between the second summer 25 associated with the first device 2, respectively the second summer 35 associated with the second device 3, and the mixer 27 associated with the first device 2, respectively the mixer 37 associated with the second device 3. Said “global” transfer function therefore models, preferably, the loudspeaker electronic power amplification circuit 23 of the loudspeaker 21 of the first device 2, respectively the loudspeaker electronic power amplification circuit 33 of the loudspeaker 31 of the second device 3, the loudspeaker 21 of the first device 2, respectively the loudspeaker 31 of the second device 3, the acoustic transfer function in the ear O1, O2 of the user between the first microphone 22 of the first device 2, respectively the first microphone 32 of the second device 3, and the loudspeaker 21 of the first device 2, respectively the loudspeaker 31 of the second device 3, and the post-microphone power amplification module 221 associated with the first device 2, respectively the post-microphone power amplification module 321 associated with the second device 3.

For each filter module 26, 36, the estimated transfer function ĥ₁, ĥ₂ is determined in advance, preferably as a function of the characteristics of the associated first and second device 2, 3, for example as a function of the type of in-ear protection, and of the corresponding characteristics of the ear O1, O2, of the user, for example, as a function of the characteristics of the ear canal and eardrum. The estimated transfer function ĥ₁ of the filter module 26 associated with the first device 2 may possibly be different from the estimated transfer function ĥ₂ of the filter module 36 associated with the second device 3.

The mixer 27 associated with the first device 2, respectively the mixer 37 associated with the second device 3, is configured to receive as input the pre-output signal s₁ corresponding to the first device 2, respectively the pre-output signal s₂ corresponding to the second device 3, to subtract therefrom the filtered environmental noise signal brf₁ by the filter module 26 associated with the first device 2, respectively the filtered environmental noise signal brf₂ by the filter module 36 associated with the second device 3, and to output the output signal x₁ corresponding to the first device 2, respectively the output signal x₂ corresponding to the second device 3.

Preferably, the communication device 1 further comprises, for each device 2, 3, an associated adaptive gain module 28, 38. The adaptive gain module 28, 38 is configured to allow an adaptive gain adjustment (at most equal to 1) of the environmental noise source signal brs₁, brs₂, in order to allow, respectively, an attenuation of the environmental noise source signal brs₁ of the first device 2 and of the environmental noise source signal brs₂ of the second device 3, before generating, respectively, the environmental noise signal br₁ corresponding to the first device 2 and the environmental noise signal br₂ corresponding to the second device 3. As represented in FIG. 1, the communication device 1 is configured in such a way that the attenuation of the environmental noise source signal brs₁, brs₂ is preferably performed in the same way on the environmental noise signal br₁, br₂ intended to be transmitted to the filter module 26, 36 and on the environmental noise signal br₁, br₂ intended for transmission to the loudspeaker 21, 31.

Preferably, the communication device 1 further comprises a sound level calculation module 7 configured to measure an environmental noise sound level based on the environmental noise signal br₁ corresponding to the first device 2 and the environmental noise signal br₂ corresponding to the second device 3, for example by taking an average of the sound levels measured for each of the two signals br₁, br₂. Preferably, the communication device 1 is configured to define a gain g₁, g₂ of the adaptive gain modules 28, 38 as a function of the sound level calculated by the sound level calculation module 7.

Still preferably, the adaptive gain modules 28, 38 are identical, and the gain g₁ of the adaptive gain module 28 associated with the first device 2 is equal to the gain g₂ of the adaptive gain module 38 associated with the second device 3, in order to guarantee good perception of the sound environment.

Preferably, each adaptive gain module 28, 38 is configured so that the sound level of each environmental noise signal br₁, br₂ generated by the loudspeaker 21, 31 is less than or equal to a threshold value. Preferably, the threshold value is a maximum of 75 dBA with respect to the free field conditions.

Even more preferably, the communication device 1 further comprises, for each device 2, 3, an associated correction module 281, 381, located downstream of the associated adaptive gain module 28, 38.

The correction module 281, 381 is configured to allow correction of the gain-adjusted environmental source noise signal brs₁, brs₂, prior to generating the environmental noise signal br₁, br₂, in order to allow, respectively, a correction of the gain-adjusted environmental noise source signal brs₁ of the first device 2, and the gain-adjusted environmental noise source signal brs₂ of the second device 3. The correction module 281, 381 is determined in order to obtain a flat insertion loss in the frequency domain [100 Hz-6 kHz], in other words, with or without protection, the low-level environmental noise should be identical in this frequency domain. The correction of the environmental noise source signal brs₁, brs₂, in particular, allows the user to be provided with an open-ear experience, in other words, an experience similar to the experience without a first and second device 2, 3 arranged in the ear O1, O2, and allows a more natural listening experience for the user when the sound of the environmental noise signal br₁, br₂ is generated by the loudspeaker 21, 31 of the associated first and second device 2, 3.

As represented in FIG. 1, the communication device 1 is configured in such a way that the correction is preferably made in the same way for the environmental noise signal br₁, br₂ intended to be transmitted to the filter module 26, 36, and on the environmental noise signal br₁, br₂ intended to be transmitted to the loudspeaker 21,31.

In order to promote a homogeneous and natural restitution of the sound environment between the two ears of the user, with the transfer function of a correction module 281 associated with the first device 2 being denoted Hₙ₁, and the transfer function of a correction module 381 associated with the second device 3 being denoted Hₙ₂, then, preferably, Hₙ₁, g₁, a₁, Hₙ₂, g₂ and a₂ are adjusted so that h₁×Hₙ₁×g₁×a₁=h₂×Hₙ₂×g₂×a₂.

The skilled person will understand that, as an alternative to the embodiment represented in FIG. 1, the sound environment restitution can also be implemented only for the first device 2 or only for the second device 3.

Referring to FIG. 1, the operating principle of the invention can be illustrated mathematically, with sound environment restitution, then:

$$x = {x}_{1} + {x}_{2}$$

$$With {x}_{1} = {s}_{1} - b r {f}_{1} = p {s}_{1} \times {A}_{m 1} - b {r}_{1} \times {\hat{h}}_{1}$$

$$And {x}_{2} = {s}_{2} - b r {f}_{2} = p {s}_{2} \times {A}_{m 2} - b {r}_{2} \times {\hat{h}}_{2}$$

$$Then {x}_{1} = ( s \times {c}_{1} + ( b {r}_{1} - p ) \times {h}_{1} \times {a}_{1} ) \times {H}_{1} \times {A}_{m 1} - b {r}_{1} \times {\hat{h}}_{1}$$

$$and {x}_{2} = ( s \times {c}_{2} + ( b {r}_{2} + p ) \times {h}_{2} \times {a}_{2} ) \times {H}_{2} \times {A}_{m 2} - b {r}_{2} \times {\hat{h}}_{2}$$

In a theoretical case, it can be assumed that the speaker bone conduction and the acoustic transfer function are identical for the first and second ears O1, O2, in other words, that c₁=c₂=C and that H₁=H₂=H, since the head of the user is symmetrical, that the transfer functions of the loudspeakers 21, 31 are identical, in other words, h₁=h₂=h, since the loudspeakers 21, 31 are identical, that the power amplifications are identical, in other words, a₁=a₂=a and Aₘ₁=Aₘ₂=Aₘ, and that the estimated transfer functions are identical, in other words, h₁=h₂=h, since the first 2 and the second 3 devices and the first O1 and the second O2 ears are identical. Furthermore, the estimated transfer functions can be considered to correspond to the “real” transfer functions, in other words, ĥ=h×a×H×Aₘ.

$$Then {x}_{1} = ( s \times c + ( b {r}_{1} - p ) \times h \times a ) \times H \times {A}_{m} - b {r}_{1} \times h \times a \times H \times {A}_{m}$$

$$and {x}_{2} = ( s \times c + ( b {r}_{2} + p ) \times h \times a ) \times H \times {A}_{m} - b {r}_{2} \times h \times a \times H \times {A}_{m}$$

$$Then x = 2 \times s \times c \times H \times {A}_{m} .$$

In practice, it may happen that the loudspeakers 21, 31 or the first microphones 22, 32 are not strictly identical, or that the characteristics of the right and left ears of the user are slightly different. In this case, the communication device 1 is preferably configured to compensate for these differences, for example by slightly adjusting the power amplifications of the loudspeaker electronic power amplification modules 23, 33 and the post-microphone power amplification modules 221, 321, in such a way that h₁×a₁×H₁×Aₘ₁=h₂×a₂×H₂×Aₘ₂=h×a×H×Aₘ. Furthermore, due to modeling, there is often an error e between the estimated and the “real” transfer functions, in other words, ĥ=h×a×H×Aₘ+e.

Repeating the above equations gives:

$${x}_{1} = s \times {c}_{1} \times {H}_{1} \times {A}_{m 1} + ( b {r}_{1} - p ) \times h \times a \times H \times {A}_{m} - b {r}_{1} \times ( h \times a \times H \times {A}_{m} + e )$$

$$and {x}_{2} = s \times {c}_{2} \times {H}_{2} \times {A}_{m 2} + ( b {r}_{2} + p ) \times h \times a \times H \times {A}_{m} - b {r}_{2} \times ( h \times a \times H \times {A}_{m} + e ) , then$$

$$x = s \times ( {c}_{1} \times {H}_{1} \times {A}_{m 1} + {c}_{2} \times {H}_{2} \times {A}_{m 2} ) - ( b {r}_{1} + b {r}_{2} ) \times e , then$$

$$x = s \times {H}_{1} \times {A}_{m 1} \times ( {c}_{1} + {c}_{2} \times \frac{{h}_{1} \times {a}_{1}}{{h}_{2} \times {a}_{2}} ) - ( b {r}_{1} + b {r}_{2} ) \times e$$

Thus, the total output signal x is free of the speech signal components-p, p, in such a way that the communication device 1 allows an echo-cancellation function, and the restitution of the sound environment sent to the interlocutor is reduced to a minimum, as long as the error e is low.

As mentioned above, in the case of in-ear sound pickup, due to the occlusion effect and the bone transmission effect, the voice s, of the user, in other words, the speech signal, is strongly amplified in the low-frequency range, particularly below 500 Hz. Preferably, the total output signal x is therefore processed before being transmitted to a communication apparatus, using the total output signal processing module 6, in order to reduce the occlusion effect and the bone transmission effect to render the sound of the voice s of the user more natural for the interlocutor, and thus improve speech quality and intelligibility. These processings are already known, for example from the previously mentioned scientific publication “Hearing protection: Surpassing the limits to attenuation imposed by the bone-conduction pathways” and will not be detailed here.

The total output signal processing module 6 may also comprise an amplification module.

FIG. 2 represents schematically a communication device 1 according to a preferred embodiment of the invention. It can be seen in FIG. 2 that a large part of the operations executed, represented functionally in FIG. 1, on intermediate signals, in other words, signals used by the communication device 1 between the at least one source speech signal and the total output signal and between the total output signal and the at least one return speech signal, are executed by a processor Proc.

Thus, the first summer 4, the second summers 25, 35 and the mixers 27, 37 are preferably implemented by a processor programmed to perform these functions. However, it is understood that, alternatively, the first summer 4, the second summers 25, 35 and the mixers 27, 37 could also be implemented by several processors or by one or more electronic circuits, in particular a microcontroller, a microprocessor, a digital signal processor (DSP), a field-programmable gate array (FPGA) or an application-specific integrated circuit (ASIC).

Furthermore, the modules, in particular the source speech signal processing module 5, the phase shifting module 50, the total output signal processing module 6, the post-microphone power amplification modules 221, 321, the filter modules 26, 36, the adaptive gain modules 28, 38, the correction modules 281, 381, and the sound level calculation module 7, are preferably implemented by a processor programmed to execute these functions. It will be understood, however, that as an alternative, the modules could be implemented by several processors or by one or more electronic circuits, in particular a microcontroller, a microprocessor, a digital signal processor (DSP), a field-programmable gate array (FPGA) or an application-specific integrated circuit (ASIC).

As an alternative to the embodiment described above, it will be understood that the electronic power amplification circuits 23, 33 of the loudspeakers 21, 31 could also, alternatively, be implemented by one or more processors, or several circuits of the microcontroller, microprocessor, digital signal processor (DSP), field-programmable gate array (FPGA) or application-specific integrated circuit (ASIC) type.

The communication device is powered by at least one from among a built-in battery or a remote battery (wired power supply).

A communication device 1 according to the invention further allows the implementation of a communication system configured to allow a user to participate in a full-duplex communication with at least one interlocutor with in-ear sound pickup for the user. Such a system comprises a communication device 1 according to the invention for the user, at least one user communication apparatus for the user and at least one interlocutor communication apparatus for each interlocutor. Each user communication apparatus is adapted to communicate with at least one of the interlocutor apparatuses, each user communication apparatus is configured to transmit at least one source speech signal p₀, −p₀ to the user communication device 1, and the user communication device 1 is configured to output a total output signal x intended to generate at least one return speech signal pᵣ, −pᵣ intended to be transmitted to at least one of the interlocutor communication apparatuses by one of the user communication apparatuses. Preferably, the interlocutors also use a communication device 1 according to the invention.

The communication apparatuses are, for example, selected from among a radio, a walkie-talkie, a telephone, a smartphone, a digital tablet, and a computer.

1. A communication device allowing full duplex with in-ear sound pickup, the communication device being configured to receive at least one source speech signal transmitted by at least one communication apparatus and to provide a total output signal, the communication device comprising:
a first device intended to be inserted into one from among a right ear and a left ear of a user, and
a second device intended to be inserted into the other from among the right ear and the left ear of the user;
each from among the first device and the second device comprising a first microphone and a loudspeaker configured to be arranged, in use, facing an ear canal of the user;
wherein:
the communication device is configured in such a way that a first speech signal is provided to the loudspeaker of the first device and a second speech signal is provided to the loudspeaker of the second device, the first and second speech signals being based on the at least one source speech signal in such a way that the first speech signal and the second speech signal are in phase opposition, in other words, phase-shifted by Pi;
the first microphone of the first, respectively second, device is configured to pick up, in the respective ear, at least one voice of the user and one sound of the first, respectively second, speech signal generated by the loudspeaker of the first, respectively second, device, and to output a sound pickup signal of the first, respectively second device;
the communication device is configured to generate a pre-output signal corresponding to the first device and a pre-output signal corresponding to the second device, respectively, from the sound pickup signal of the first and the second devices, and to generate an output signal corresponding to the first device and an output signal corresponding to the second device, comprising, respectively, at least one component related to the pre-output signal corresponding to the first device and one component related to the pre-output signal corresponding to the second device; and
the communication device further comprises a first summer configured to receive as input and to sum the output signal of the first device and the output signal of the second device, the first summer outputting the total output signal equal to the sum of the output signal of the first device and the output signal of the second device, and the total output signal comprising a voice component of the user and being free of components of the first and second speech signals.

2. The communication device according to claim 1, wherein the communication device further comprises a total output signal processing module configured to process the total output signal in order to generate, from the total output signal, at least one from among a return speech signal and two return speech signals in phase opposition, the processing being at least one from among a reduction in the occlusion effect, a reduction in the bone transmission effect, and an amplification, in order to render the total output signal more natural for the interlocutor.

3. The communication device according to claim 1, wherein that the communication device is configured to receive two source speech signals in phase opposition coming from each communication apparatus, to use one of the two source speech signals in order to generate the first speech signal and provide it to the loudspeaker of the first device, and to use the other of the two source speech signals to generate the second speech signal and provide it to the loudspeaker of the second device.

4. The communication device according to claim 1, wherein the communication device comprises a source speech signal processing module configured to receive a single source speech signal coming from each communication apparatus and to generate the first speech signal and the second speech signal in phase opposition from the at least one source speech signal.

5. The communication device according to claim 4, wherein the communication device is configured to phase-shift by Pi, the at least one source speech signal in order to generate the first speech signal, and not to phase-shift the source speech signal in order to generate the second speech signal.

6. The communication device according to claim 1, wherein at least one device, referred to as a sound environment restitution device, from among the first device and the second device comprises a second microphone, arranged on an external surface of the at least one sound environment restitution device and directed toward the exterior, the second microphone being configured to pick up an environmental noise and output an environmental noise source signal to the at least one sound environment restitution device;
the communication device being configured to generate an environmental noise signal corresponding to the at least one sound environment restitution device from the environmental noise source signal;
the communication device further comprises, for each sound environment restitution device:
a second summer configured to receive as input and to sum the environmental noise signal corresponding to the at least one sound environment restitution device and the speech signal configured to be provided to the loudspeaker of the at least one sound environment restitution device, and to output the sum to the loudspeaker of the at least one sound environment restitution device;
a filter module, connected to the second microphone configured to receive the environmental noise signal corresponding to the at least one sound environment restitution device, to filter the environmental noise signal corresponding to the at least one sound environment restitution device by an estimated transfer function, and to output a filtered environmental noise signal; and
a mixer, the first microphone of the at least one sound environment restitution device being further configured to pick up, in the respective ear, a sound of the environmental noise signal corresponding to the at least one sound environment restitution device generated by the loudspeaker of the at least one sound environment restitution device, the mixer being configured to receive as input and to subtract the pre-output signal corresponding to the at least one sound environment restitution device and the filtered environmental noise signal, and to output the output signal corresponding to the at least one sound environment restitution device, the output signal corresponding to the at least one sound environment restitution device being equal to the pre-output signal corresponding to the at least one sound environment restitution device from which the filtered environmental noise signal is subtracted, and the output signal corresponding to the at least one sound environment restitution device being free of the environmental noise signal component corresponding to the at least one sound environment restitution device;
for each sound environment restitution device, the estimated transfer function modeling a global transfer function between the second summer and the mixer.

7. The communication device according to claim 6, wherein the communication device further comprises, for each sound environment restitution device, an adaptive gain module allowing to attenuate the environmental noise source signal of the at least one sound environment restitution device before generating the environmental noise signal corresponding to the at least one sound environment restitution device intended to be transmitted to the loudspeaker of the at least one sound environment restitution device.

8. The communication device according to claim 7, wherein the attenuation of the environmental noise source signal of the at least one sound environment restitution device depends on a sound level of the environmental noise signal.

9. The communication device according to claim 7, wherein the communication device is configured in such a way that the attenuation allows that the sound level of the environmental noise signal corresponding to the at least one sound environment restitution device generated by the loudspeaker of the at least one sound environment restitution device is always below a threshold value.

10. The communication device according to claim 1, wherein at least one operation executed by the communication device, on the at least one source speech signal or on an intermediate signal between the at least one source speech signal and the total output signal, is executed by a processor.

11. The communication device according to claim 1, wherein the total output signal processing module is implemented by at least one from among a processor, a microcontroller, a microprocessor, a digital signal processor, a field-programmable gate array, an application-specific integrated circuit.

12. The communication device according to claim 1, wherein at least one from among the first device and the second device is an in-ear hearing protector.

13. A communication system able to allow a user to participate in full duplex communication with at least one interlocutor with in-ear sound pickup for the user, wherein the system comprises communication device according to claim 1 for the user, at least one user communication apparatus for the user and at least one interlocutor communication apparatus for each interlocutor, each user communication apparatus being able to communicate with at least one of the interlocutor apparatuses, each user communication apparatus being configured to transmit at least one source speech signal to the user communication device, and the user communication device being configured to output a total output signal intended to generate at least one return speech signal intended to be transmitted to at least one of the interlocutor communication apparatuses by one of the user communication apparatuses; the interlocutors possibly using a communication device according to claim 1.

14. The system according to claim 13, wherein at least one of the communication apparatuses is one from among a radio, a walkie-talkie, a telephone, a smartphone, a digital tablet and a computer.
